(19) United States
(12) Patent Application Publication
(10) Pub. No.: US 2005/0060899 A1
(43) Pub. Date: Mar. 24, 2005

(54) Invisible target illuminators for 3D camera-based alignment systems

(75) Inventors: David A. Jackson, Point Robert, WA (US); Eric F. Bryan, Conway, AR (US); Michael J. Robb, San Jose, CA (US)

Correspondence Address: MCDERMOTT, WILL & EMERY, 600 13th Street, N.W., Washington, DC, 20005-3096, US

(73) Assignee: SNAP-ON TECHNOLOGIES, INC.

(21) Appl. No.: 10/667,522

(22) Filed: Sep. 23, 2003

(51) Int. Cl. G01B 5/24

(52) U.S. Cl. 33/203.18

(57) ABSTRACT

A three-dimensional camera based system for determining the position and/or alignment of objects such as motor vehicle wheels. The system includes a strobed infrared lighting subsystem, a visible indicator that the subsystem is working properly, and targets for attachment to the objects. The system also includes at least one camera for viewing the targets, and a data processor connected to the camera for processing data relating to images of the targets to determine position and/or alignment information, and a display that displays the position and/or alignment information. The system includes directional indicators for indicating that the vehicle should be repositioned by moving it backward, forward, or steered left or right. The system also includes wheel indicators tied in with software on the data processing device. These wheel indicators indicate the state of target acquisition by the data processing device based on the image from the camera.

### FIELD OF THE DISCLOSURE

The present disclosure relates generally to motor vehicle alignment and, more particularly, to target illuminators outside the visible light spectrum that are suitable for three-dimensional camera based alignment systems.

### BACKGROUND OF THE DISCLOSURE

Wheel alignment systems are capable of obtaining position or orientation information about a vehicle, such as ride height, toe curve, tilt angle and the angle of a vehicle's body relative to the vehicle's wheels.

The wheels of a motor vehicle may be aligned using a vision imaging system, such as a computer-aided, three-dimensional (3D) machine vision that employs image sensing devices, such as cameras to determine the position of various target devices. Although such imaging systems are typically used for alignment purposes, these systems can also be used to obtain other positional and angular orientation information about a vehicle. Examples of such apparatuses and methods are described in U.S. Pat. No. 5,724,743, entitled “Method and Apparatus for Determining the Alignment of Motor Vehicle Wheels,” issued to Jackson et al., on Mar. 10, 1998 and in U.S. Pat. No. 5,535,522 entitled “Method and Apparatus for Determining the Alignment of Motor Vehicle Wheels,” issued to Jackson et al. on Jul. 16, 1996. Each of these patents is incorporated by reference herein the same as if fully set forth.

To determine the alignment of a motor vehicle's wheels, such 3D aligners generally employ video cameras that view targets affixed to the wheels. The image information from the video camera is sent to a computer, and alignment is determined based on calculations made by software in the computer.

In order for the cameras to view the targets for alignment purposes, the target is generally illuminated. Accordingly, in addition to the image sensing devices incorporated by 3-D based camera aligner systems, these 3-D based camera aligner systems may also incorporate light source subsystems. When such light sources subsystems are employed, the camera (or other image sensing device) may include an electronic shutter which is synchronized with one or more strobed light sources so that an image is captured only when a particular target or targets are illuminated. Examples of such light source subsystems are described in U.S. Pat. No. 5,809,658, entitled “Method and Apparatus for Calibrating Cameras Used in the Alignment of Motor Vehicle Wheels,” issued to Jackson et al., on Sep. 22, 1998. The apparatus disclosed in these patents is sometimes called a “3D aligner” or an “aligner”, and is herein at times referred to as a vision imaging system.

Current illuminators in 3D camera based alignment systems use red light emitting diodes (LEDs). These LED's are sometimes strobed so that the image is captured when a particular target or targets is illuminated.

Light sources in the visible red spectrum may cause operator eye strain. Sometimes, when increased power output is needed for a 3D aligner, eye strain is aggravated by the increased light intensity. Moreover, red light can be distracting to the operator.

There is a need for a wheel alignment system that provides target illumination at reduced distraction to the operator.

There is further a need for a wheel alignment system that provides target illumination that does not aggravate eye strain, particularly when increased power output is needed.

### SUMMARY OF THE DISCLOSURE

The present disclosure addresses the needs noted above by providing an invisible light source for target illumination in a 3-D camera based alignment system.

According to one aspect of the present disclosure, a 3-D camera based wheel alignment system incorporating a strobed infrared light source is provided. The system includes an array of 64 infrared LEDs operatively coupled to a strobe circuit. The LEDs, controlled by the strobe circuit, emit strobed invisible light. Because this light is not visible to the operator, the system also includes a visible indicator that emits light within the visible spectrum, to indicate to the operator that the LEDs are operative. The strobed invisible light illuminates a target attached to a vehicle's wheels and is retro-reflected to a CCD or CMOS camera. The camera includes an electronic shutter that is synchronized with the array of LEDs so that an image is captured only when a target is illuminated. The camera detects and forms an image of the target. The camera then generates image information for the target device, and sends this information to a computer. The computer determines the orientation of the vehicle's wheels based on the generated target image.

One advantage of the present disclosure is to provide a 3-D camera based alignment system that reduces eye strain, and that provides for increased power output without an increase in eye strain.

Another advantage of the present disclosure is to provide a 3-D camera based aligner that is less distracting to the operator.

Another advantage of the present disclosure is to provide directional indicators that are readily visible to a wheel alignment technician. These directional indicators indicate a direction in which the vehicle should be moved or steered to assist in proper alignment.

Another advantage of the present disclosure is to provide wheel indicators that are easily visible to a wheel alignment technician. These wheel indicators indicate to the technician whether the alignment software has successfully acquired the target attached to a vehicle's wheels.

### BRIEF DESCRIPTION OF THE DRAWINGS

These and other objects, features, and characteristics of the present disclosure will become apparent to one skilled in the art from a close study of the following detailed description in conjunction with the accompanying drawings and appended claims, all of which form a part of this application. In the drawings:

FIG. 1 is an example of a two-camera position determination system for which the light subsystem of the present disclosure can be implemented.

FIG. 2 illustrates further detail of the camera and lighting components in a position determination system in accordance with the present disclosure.

FIG. 3 is a top plan view of an alignment target that may be used in an embodiment of the present disclosure.

FIG. 4 illustrates another example of a wheel alignment system—a single camera embodiment—implemented according to the present disclosure.

FIG. 5 illustrates an electrical circuit diagram of an LED array scheme in accordance with one embodiment of the present disclosure.

FIG. 6 illustrates an embodiment of the light array of FIG. 5 as viewed by the technician.

FIG. 7 illustrates the light array embodiments of FIGS. 5 and 6 when covered with a silk screen.

### DETAILED DESCRIPTION OF THE DISCLOSURE

Wheel alignment systems may use a vision imaging system that employs image (or optical) sensing devices to determine the positions of various target devices. These types of wheel alignment systems are capable of obtaining positional information about a vehicle, such as ride height, toe curve, tilt angle, and the angular relationship of the vehicle's body relative to the vehicle's wheels. Three-dimensional camera based wheel aligners employ image sensing devices such as cameras to determine the positions of various target devices. Although such vision imaging systems are typically used for alignment purposes, these systems can also be used to obtain other positional and angular orientation information about a motor vehicle. Devices capable of obtaining this additional information are referred to herein as position determination systems.

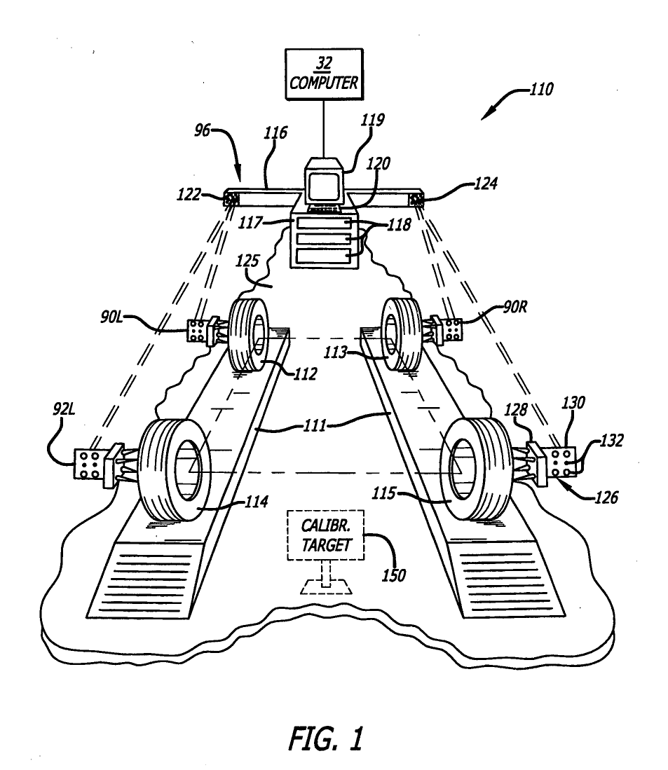

An example of a position determination system (including a wheel alignment system) on which the present disclosure may be implemented is illustrated in FIG. 1. This illustration sets forth a schematic top plan view of certain elements of a computer-aided, 3D motor vehicle wheel alignment system (“aligner”) 110 employing two cameras. Aligner 110 has a pair of fixed, spaced-apart camera/light source subsystems 122, 124. A four-wheeled vehicle positioned on a lift ramp 111 for wheel alignment is suggested by the four wheels 112, 113, 114, and 115. In the usual case, the rack 111 will include pivot plates (not shown) to facilitate direction change of at least the front wheels.

A superstructure 96 includes a horizontally extending beam 116 affixed to a cabinet 117. The cabinet 117 may include a plurality of drawers 118 for containing tools, manuals, parts, etc. Alternatively, cabinet 117 may comprise a stand, rigid set of legs, or other support structure. Cabinet 117 may also form a support for a video monitor 119 and input keyboard 120. Computer 32 or other data processing device that includes memory, both ROM and RAM, is coupled to video monitor 119 and input keyboard 120 and may be located within cabinet 117 or in another location. Computer 32 operates under control of one or more stored programs that implement the processes and methods described in this document. The programs are generally preloaded before installation of aligner 110 in a shop environment.

Left and right camera and light source subsystems 122, 124 (“camera/light subsystems” or “cameras”) are mounted at each end of the beam 116. The length of beam 116 is chosen so as to be long enough to position the camera/light subsystems outboard of the sides of any vehicle to be aligned by the system. The beam and camera/light subsystems 122, 124 are positioned high enough above the shop floor 125 to ensure that the two targets 90L, 92L on the left side of the vehicle are both within the field of view of camera assembly 122, and the two targets 90R, 130 on the right side of the vehicle are both within the field of view of camera assembly 124. In other words, the cameras are positioned high enough that their line of view of a rear target is over the top of a front target. This can, of course, also be accomplished by choosing the length of beam 116 such that the cameras are outside of the front targets and have a clear view of the rear targets.

Mounted within beam 116, each camera/light subsystem 122, 124 includes a lighting unit, comprised of a plurality of light emitting diode (LED) light sources arrayed about an aperture through which the input optics of a suitable video camera is projected.

In order to discriminate against other possible sources of light input to the camera, a narrow band filter matched to the light spectrum of the LEDs may be positioned in front of the lens. Any suitable type of video camera can be utilized, including a CMOS camera. However, in accordance with this embodiment, a charge-coupled device (CCD) camera is used. This camera has a resolving power suitable for the present application.

Although the embodiment described herein uses infrared LEDs, it should be understood that illumination could be provided in other ranges of the light spectrum, including ultraviolet light. In addition, it should also be noted that light in other ranges of the spectrum could also be used, including but not limited to, x-rays, gamma rays, radio waves, and the like, and that suitable operator protection might be needed where appropriate.

In accordance with this embodiment, a target device 126, including a rim-clamp apparatus 128 and a target object 130, is attached to each wheel. A suitable rim-clamp mechanism is discussed in U.S. Pat. No. 5,024,001 entitled “Wheel Alignment Rim Clamp Claw.” As will be described in more detail below, the target object may have at least one planar, light-reflective surface with a plurality of camera-perceptible, geometrically configured, retro-reflective target elements 132 formed thereon. Such target surfaces may be formed on one or more sides of the target object. In use, each target must be positioned on a vehicle wheel with an orientation such that the target elements are within the field of view of at least one of the camera/light subsystems.

A computer-generated quasi three-dimensional representation of the wheels being aligned may be depicted on the video monitor 119 under control of programs of computer 32, along with suitable indicia evidencing the detected alignment. In addition, alphanumeric and/or pictorial hints or suggestions may be depicted to guide the technician in adjusting the various vehicle parameters as required to bring the alignment into conformance with predetermined specifications. These functions are implemented by programs of computer 32. An example of a commercial product that is suitable for use as aligner 110 is the VISUALINER 3D, commercially available from John Bean Company, Conway, Ark.

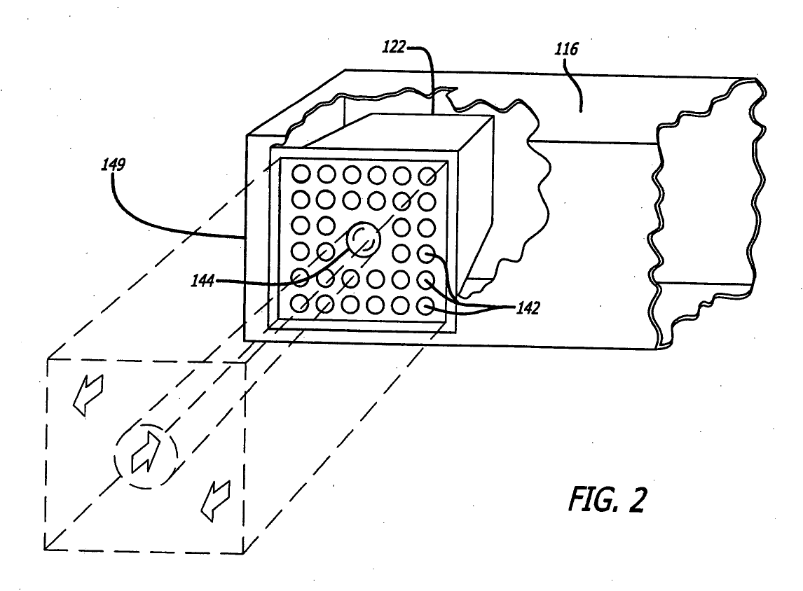

Referring now to FIG. 2, illustrated is further detail of the camera and lighting components. The light array in this embodiment includes 64 LEDs (a lesser number being shown for simplicity of illustration) which provide a high-intensity source of on-axis illumination surrounding the camera lens, to ensure that maximum light is retro-reflected from the targets. It should be understood, however, that a lesser number of LEDs could be used so long as the intensity of the LEDs is sufficient to illuminate the targets so that a sufficient amount of light is retro-reflected from the targets.

The infrared LEDs are operatively coupled to a strobe circuit. If desired, the strobe circuit could include controls for adjusting the strobe time. Strobed infrared light is particularly suitable for use with the camera based aligner because, although invisible to the human eye, it is more readily and accurately read electronically.

In order to assist the operator of the position determination system, the system may also include a visible indicator that indicates to the operator that the system is working properly. For example, the visible indicator could indicate, by failing to emit red light, that one or more invisible LEDs is not operating properly. This visible indicator can emit light that falls within any range of the visible spectrum, including but not limited to green and red. The visible indicator can be located in any location convenient for operator viewing, including but not limited to the outside portions of the camera/light subsystem 122 at position 149.

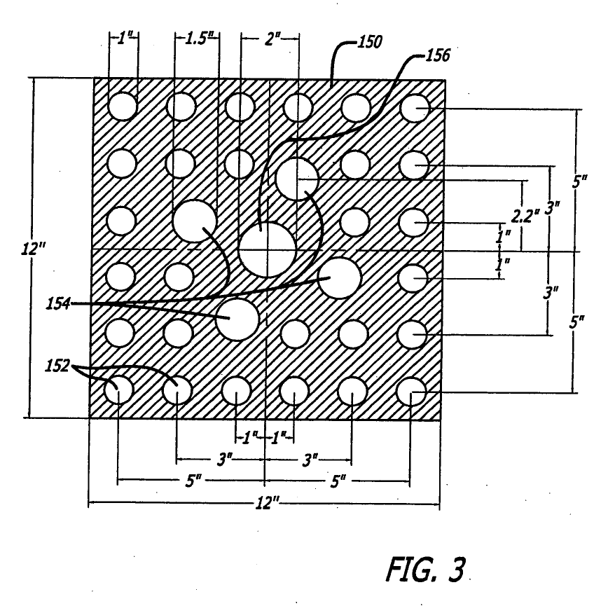

FIG. 3 is a top plan view of an alignment target 150 that may be used in an embodiment as targets 90L, 92L, 90R, 130.

Target 150 is an example of a target in accordance with one embodiment of the present disclosure and includes a plurality of light-reflective, circular target elements or dots of light-colored or white retro-reflective material disposed in an array over a less reflective or dark-colored of a rigid substrate. Suitable retro-reflective materials include Nikkalite.TM. 1053 sold by Nippon Carbide Industries USA, Scotchlite.TM. 7610 sold by 3M Company, and D66-15xx.TM. sold by Reflexite, Inc.

The target 150 includes multiple circular dots so as to ensure that sufficient data input may be captured by the camera even in the case that several of the target elements have been smudged by handling or are otherwise not fully detectable. In accordance with this embodiment, a well-defined target includes approximately 30 circular dots very accurately positioned (within 0.0002″) with respect to each other. By way of specific example, the target illustrated in FIG. 2 might include 28 circular dots, each having an area one unit, very accurately positioned on a 12″.times.12″ grid, with four dots having an area of 1.5 units, and a single dot having an area of 2 units, strategically positioned within the array. The precise size and spacing of the dots is not critical provided that dots having a plurality of different area measurements are used, and the area measurements and relationship of the dots having different area measurements is known and stored in advance.

In this configuration, in operation each of the cameras 122, 124 views the physical targets 90L, 92L, 90R, 130. Computer 32 receives images formed by the cameras and under program control, creates a stored image of the targets. In memory, computer 32 also has a pre-defined mathematical representation of an image of an ideal target (the “target model”) and a mathematical representation of the camera system (“camera model”). Examples of how this mathematical representations are created are disclosed in the aforementioned U.S. Pat. No. 5,724,743, entitled “Method and Apparatus for Determining the Alignment of Motor Vehicle Wheels,” issued to Jackson et al., on Mar. 10, 1998 which has been incorporated by reference herein the same as if fully set forth.

As a result, computer 32 can create and store in its memory a representation of an image (“hypothesized image”) that the target model would have produced when viewed through the camera model, as if the target model and camera model are a physical target and camera. Computer 32 can then compare the hypothesized image to a stored image formed by the cameras 122, 124 by viewing physical targets 90L, 90R, 92L, 130.

By mathematically moving values representing the mathematical position of a modeled target until the mathematical position and orientation of the projected dots line up with the dots of the real target in the real image, position and orientation information can be obtained. This mathematical manipulation of a well defined target until it is oriented the same way as the image is called “fitting the target.” Once the fitting is accomplished, the position and orientation of the target is very accurately known, e.g., within 0.01″ and 0.01 degree. Such accuracy is obtainable because the target is made to very strict tolerances and because the design enables measurement of many points, e.g., 1,500 measured points from 30 or so fiducials (dots) each with 50 detected edge points. Furthermore, the use of sub-pixel interpolation enhances the accuracy of measurement to beyond the pixel resolution of the cameras.

The target is typically manufactured using a photo-lithographic process to define the dot boundaries and ensure sharp-edge transition between light and dark areas, as well as accurate and repeatable positioning of the several target elements on the target face. The target face may also be covered with a glass or other protective layer. Note that since all information obtained from a particular target is unique to that target, the several targets used to align a vehicle need not be identical and can in fact be of different makeup and size. For example, it is convenient to use larger rear targets to compensate for the difference in distance to the camera.

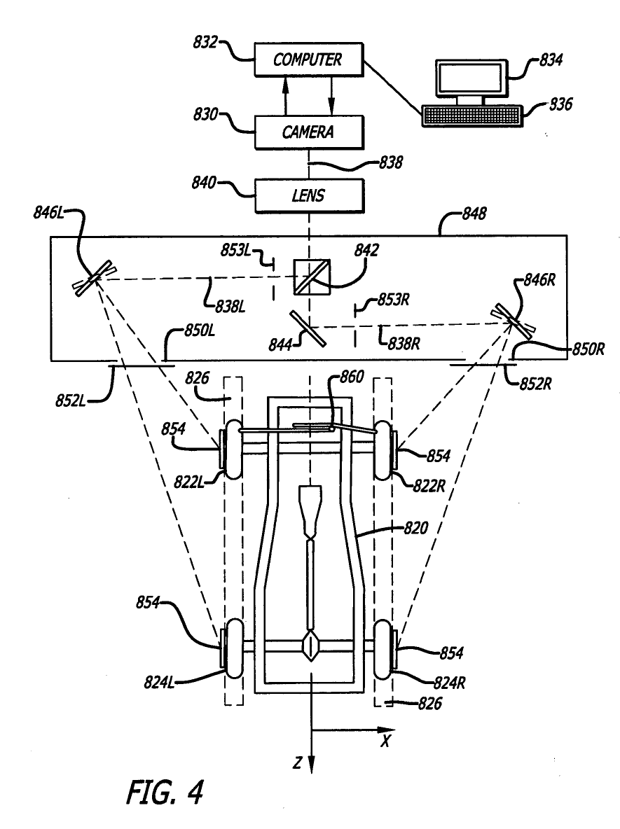

Referring now to FIG. 4, illustrated is another example of a wheel alignment system implemented according to the present disclosure. This wheel alignment system employs a single camera. A vehicle 820 is represented by a schematic illustration of a chassis of the vehicle and includes two front wheels 822L and 822R and two rear wheels 824L and 824R. The vehicle 820 is positioned on a conventional wheel alignment test bed or alignment rack 826, indicated by broken lines. Targets 854 are mounted on each wheel.

A video camera 830 is coupled to an electronic processing means such as a computer 832, data processor, or other equivalent device, that can be programmed to process information. Computer 832 can also display results such as on a visual display unit 834. An input device such as a keyboard 836 may be used for inputting data and other relevant information into computer 832. A computer-generated quasi-three-dimensional (3D) representation of the wheels being aligned may be depicted on display unit 834 along with indicia of the detected alignment. In addition, display unit 834 may depict hints or suggestions to guide the alignment technician who is performing the wheel alignment. Computer 832, display unit 834, and keyboard 836 represent a simplified representation of the type of computer hardware upon which an illustrative system may be implemented.

The video camera 830 sights onto the wheels 822L, 822R, 824L and 824R along a view path 838 that passes through a lens 840 and onto a beam splitter 842. Beam splitter 842 splits view path 838 into two components, 838L and 838R, respectively. As shown in FIG. 4, the left hand component 838L of view path 838 is reflected perpendicularly to the initial view path by beam splitter 842. Similarly, right hand component 838R is reflected perpendicularly to the initial view path by a prism or mirror 844 mounted adjacent to beam splitter 842. The apparatus also includes a housing 848 into which beam splitter 842, mirror 844, and at least two pan-and-tilt mirrors, 846L and 846R, are mounted. From this point onward the respective components of the apparatus and the view path are identical for both the left and right side of the motor vehicle, and therefore a description of only one side will suffice.

Targets 854, which are optically scannable, are attached to each of the wheels 822L and 824L. Left-hand component 838L of view path 838L is reflected onto targets 854 by left side pan-and-tilt mirror 846L. Left side pan-and-tilt mirror 846L is movable to allow video camera 830 to consecutively view front wheel 822L and rear wheel 824L of vehicle 820. Alternatively left side pan-and-tilt mirror 846L may be configured to view both front and rear wheels 822L and 824L simultaneously.

In a single camera alignment system, view path 838L passes from pan-and-tilt mirror 846L through an aperture 850L in the wall of housing 848 and onto the respective wheels 822L and 824L. Shutters may be placed at locations 853L and 853R and/or an electronic shutter within video camera 830 may be synchronized with one or more strobed light sources to permit capture of an image only when a particular target or targets are illuminated. Alternatively, a shutter may be positioned at location 852L so that it may be operated to close aperture 850L thereby effectively blocking view path 838L and allowing video camera 830 to sight onto the right hand side of vehicle 820 only.

A wheel alignment system works generally as follows: vehicle 820 is positioned on alignment rack 826, which is raised to allow the alignment technician to perform the alignment. Targets 854 are mounted onto each of wheels 822L, 822R, 824L, and 824R. The alignment apparatus forms a detected image of each target 854. These detected images are processed in computer 832, which calculates the orientation of each of the targets to the respective view paths 838L and 838R. Computer 832 may also store values corresponding to the position of each detected image.

Typically, the spindle position is also located. In this operation, computer 832 acquires images of the targets. The vehicle is rolled back, and the computer acquires a second set of images of the targets. The computer computes the angle through which the vehicle was rolled back, and based on such calculation, determines the spindle location. Optically, the vehicle can be rolled forward and remeasured as a check.

Furthermore, computer 832 makes the necessary corrections to calculate the true orientation of the wheels relative to the respective view paths and to allow for the orientation of pan-and-tilt mirrors 846L and 846R. Computer 832 may then calculate the actual orientation of the primary planes of each of wheels 822L, 822R, 824L, and 824R. A “primary plane” is an imaginary plane with a generally vertical orientation that is parallel to the tread of the tire that is part of the wheel.

The results of the computations described above are displayed on display unit 834. Computer 832 may also have display unit 834 show instructions to the alignment technician as to what corrections may need to be made to correct any detected misalignment of wheels 822L, 822R, 824L, and 824R of vehicle 820.

An alignment system of the type shown in FIG. 4 may be used to measure the distance traveled 716 and the angle of rotation 720 of each wheel 822L, 822R, 824L, and 824R as vehicle 820 is rolled from initial position 702 to final position 704.

Vehicle 820 is initially positioned on alignment rack 826 and targets 854 are attached to each wheel 822L, 822R, 824L, and 824R. The aligner takes images of each target 854 to determine an initial position 702 of each of the wheels 822L, 822R, 824L, and 824R. Computer 832 creates and stores values corresponding to the initial position 702 of each of the wheels 822L, 822R, 824L, and 824R.

Vehicle 820 is rolled from initial position 702 to final position 704. Once vehicle 820 has been rolled, the aligner takes images of each target 854 to determine a final position 704 of each of the wheels 822L, 822R, 824L, and 824R. Computer 832 creates and stores values corresponding to the final position 704 of each of the wheels 822L, 822R, 824L, and 824R. The aligner may also prompt a technician to roll the vehicle and take position measurements by appropriate instructions or signals generated by computer 832.

The aligner processes the images of initial position 702 and final position 704 of each wheel 822L, 822R, 824L, and 824R to determine both the distance traveled 716 and the angle of rotation 720 of each wheel 822L, 822R, 824L, and 824R. Under control of software or electronics, values for the distance traveled 716 and the angle of rotation 720 are created and stored. Based on these two measurements, the aligner calculates the roll radius 606 of each wheel 822L, 822R, 824L, and 824R. A roll radius value is created and stored. The aligner then presents resulting values on display unit 834 for evaluation. The alignment technician can then use such results to help diagnose the condition of the vehicle and the wheels, including whether the wheels are properly matched, if there is excessive wear on any of the wheels, whether the wheels are properly inflated, and if there is unequal suspension loading.

In moving vehicle 820 from initial position 702 to final position 304, vehicle 820 is rolled a sufficient distance to provide for accurate measurements of the distance traveled 316 and the angle of rotation 720 of each of wheels 822L, 822R, 824L, and 824R. However, there are limits on how far vehicle 820 may be moved due to practical considerations such as keeping the vehicle on alignment rack 826. The minimum angle of rotation 320 through which vehicle 820 must be rolled is about 10 degrees. Furthermore, moving the vehicle such that the angle of rotation 320 is about 30 degrees provides accurate measurements while keeping vehicle 820 on alignment rack 826.

Additional examples of procedures and systems for determining position (or orientation) information using targets and cameras are set forth in the patents which have been incorporated herein by reference. Other such procedures and systems are well known in the art.

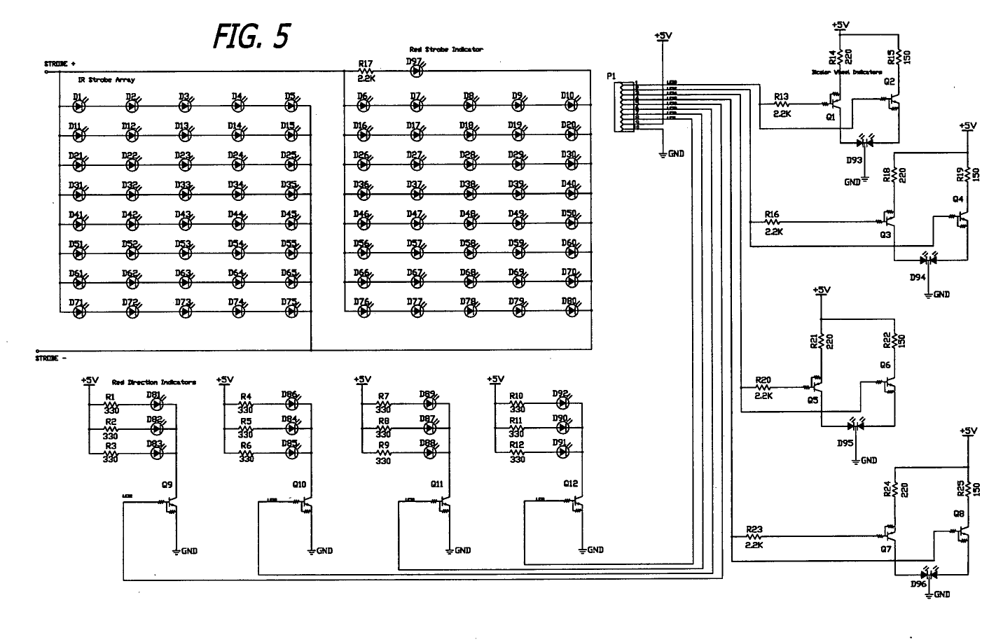

Referring now to FIG. 5, illustrated is an electronic circuit diagram of the strobe array incorporating invisible illuminators in the infrared range of the light spectrum. In this embodiment, the array includes eighty (80) LEDs labeled D1-D80, inclusive. Also illustrated is a visible indicator in the red range of the light spectrum that indicates to the technician that the infrared strobe is operative. For example, the red indicator D97 could emit light in the red range to indicate that all LEDs on the strobe array D1-D80 are working properly. The red indicator 97 could also fail to emit light when a single LED on the strobe array D1-D80 is inoperative.

This embodiment illustrated further includes four (4) bi-color wheel indicators D93-D96, inclusive, shown at the right side of the illustration. Each of these bicolor wheel indicators is associated with a particular vehicle wheel. Each set informs the technician as to whether the target for a specific wheel has been successfully acquired by the system.

A target for a specific wheel has generally been successfully acquired when alignment software loaded onto the computer has been able to process images from the camera and locate the target in space. Bi-color wheel indicators D93-D96 provide a visual indicator to the technician that the alignment software has successfully acquired the target, i.e., processed images from the camera and located the target in space.

In this embodiment, the bi-color wheel indicators D93-D96 could emit light in the green range of the visible spectrum when the target has been successfully acquired. The bi-color wheel indicators could emit light in the red range of the visible spectrum when the target has not been successfully acquired.

In addition, other target acquisition states could be indicated by the addition of LEDs in colors other than green and red of bi-color wheel indicators D93-D96. These colors would be added to the green and red LEDs of bi-color wheel indicators D93-D96. For example, where a target has been found, but is not acceptable for some reason, an additional indicator added to these bi-color wheel indicators D93-D96 might emit light in the yellow range of the visible spectrum to indicate that the target has been found, but is not acceptable. This and other states of target acquisition could be indicated when LEDs of two colors emitted light simultaneously. Such a situation might arise, for example, when the image from the camera is dirty or is partially blocked. It should be understood, however, that this “found but not acceptable” indication is merely one of many additional states that might be indicated by the bi-color wheel indicator array D93-D96.

Because of these bi-color wheel indicators (or target object indicators) D93-D96, the technician need not be within visible range of the monitor, giving the technician greater flexibility in movement and thus making the alignment process more efficient.

If the target cannot be seen for a particular wheel, the directional indicator for that wheel gives a visible indication in the red range of the light spectrum. If the target is found, the indicator for the wheel gives a visible indication in the green range of the light spectrum. Of course, it should be understood that these visible indicators can emit light in any range of the visible spectrum.

The wheel indicators D93-D96 in this embodiment are incorporated into the same printed circuit board as the strobe array and single visible indicator that the strobe is operative. However, it should be understood that these directional indicators could be incorporated into a stand-alone board.

As illustrated in FIG. 5, four (4) sets of directional indicators can be used to assist the technician in determining the direction in which a vehicle should reposition so that it might be viewed by the camera. These directions are back, forth, left or right. Each directional indicator set is representative of a different direction.

Each of the four sets of directional indicators includes three LEDs, with the first set illustrated at D81-D83, the second set at D84-D86, the third set at D87-D89 and the fourth set at D91-D93.

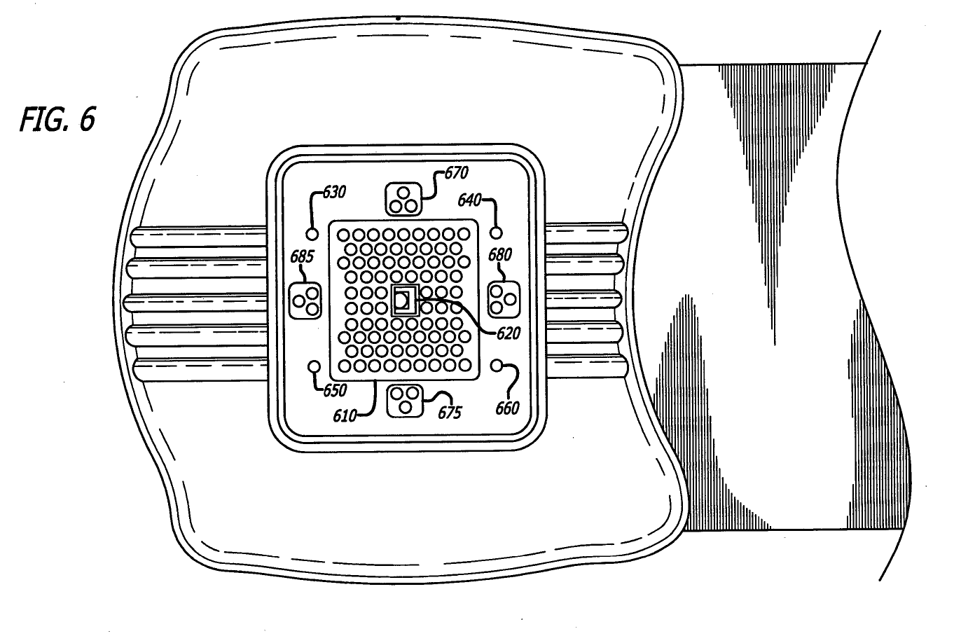

Referring now to FIG. 6, illustrated is an embodiment of the light array of FIG. 5 as viewed by the technician. The light array includes eighty (80) invisible LEDs 610 that illuminate the target. A visible indicator 620 at the center that shows the invisible array is operative. Bicolor wheel indicators 630, 640, 650, 660 are attached to a specific wheel and indicate whether the computer has successfully acquired the image for the particular wheel with which the indicator is associated. The bicolor wheel indicators 630, 640, 650, 660 might also indicate that the wheel has not been found. Software tied in with the bicolor wheel indicators 630, 640, 650, 660 and camera system might indicate when a wheel has been found, but the wheel image is unacceptable. For example, the image of the wheel might be dirty or partially blocked. In this case, the indicators 630, 640, 650, 660 might convey that the wheel was found, but the image was unacceptable. Thus, the bicolor wheel indicators 630, 640, 650, 660 would indicate one of three states of target acquisition.

Directional LEDs 670, 675, 680, 685 inform the technician as to whether the vehicle should move forward, backward, or be steered left or right in order to be viewed by the camera. Each LED of these sets 670, 675, 680, 685 forms a point on a three-point triangle of lights visible to the technician. Traditionally, this indication was shown on the monitor of the wheel alignment system and the technician was required to view the monitor in order to determine the direction in which the vehicle should move. Using the LED sets 670, 675, 680, 685 of the present disclosure, the monitor need not be viewed. These indicators can be tied in with alignment software on the system.

The light arrays of the present disclosure could be driven by a voltage source, a current source or any other suitable source. If the arrays are driven by a current source, this configuration compensates somewhat for inoperable strings of LEDs and reduces the need for resistors in the strings.

The LEDs may be rotated physically on the printed circuit board in order to provide more evenly distributed illumination. At times, due to the automated process used to create these arrays, the lights contained in the arrays may be slightly offset, thereby causing off-center illumination. Rotation of the LEDs may be accomplished through use of equipment specifically designed for this purpose. Such equipment is known in the art. The angle of rotation may be ninety degrees (90) or smaller, or any angle of rotation that provides more evenly distributed illumination. All LEDs might be in the same orientation or offset from each other.

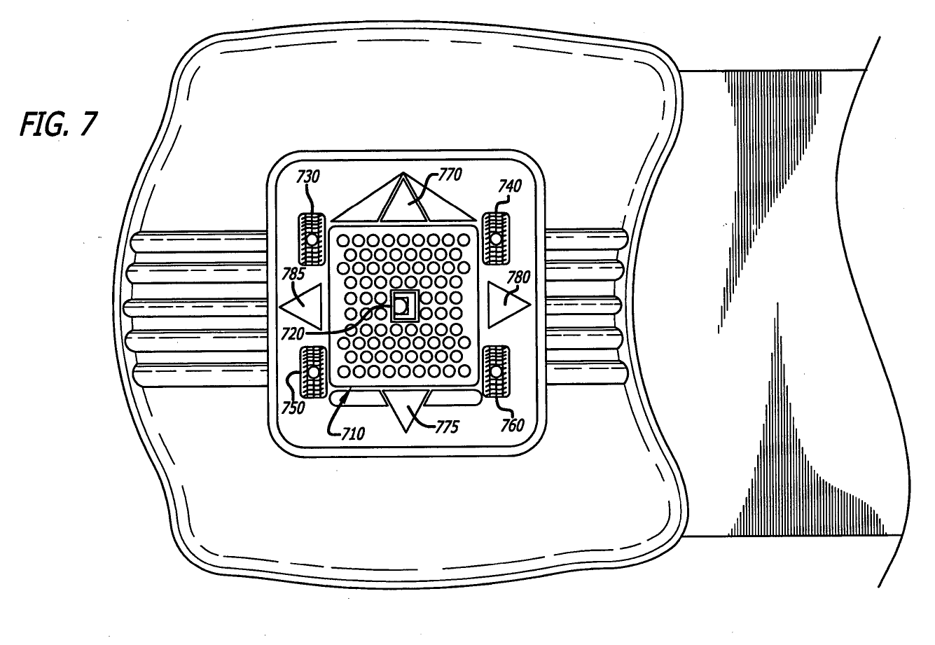

FIG. 7 is an embodiment of the light array of FIGS. 5 and 6 when the light array is covered by a silk screen. This silk-screened array may be viewed by the technician so that the technician may easily associate portions of the vehicle with portions of the light array. The light array includes eighty (80) invisible LEDs 710 that illuminate the target. The visible indicator 720 at the center shows the invisible array is operative. Bicolor wheel indicators 730, 740, 750, 760 are representative of a specific wheel and indicate whether the computer has successfully acquired the image for the particular wheel with which the indicator is associated. For example, if wheel indicator LED 730 is on, the image for the front left wheel is being acquired by the computer and its corresponding alignment software. If wheel indicator LED 740 is on, the image for the front right wheel is being acquired by the computer and its corresponding alignment software. If wheel indicator 750 is on, the image for the rear left wheel is being acquired by the computer and its corresponding alignment software. If wheel indicator 760 is on, the image for the rear right wheel is being acquired by the computer and its corresponding alignment software.

Directional LEDs 770, 775, 780, 785 inform the technician as to whether the vehicle should move forward or backward, or that the vehicle should be steered left (generally by rotating the steering wheel in a counterclockwise direction) or right (generally by rotating the steering wheel in a clockwise direction) so that it can be viewed by the camera. Each LED of these sets 770, 775, 780, 785 forms a point on a three-point triangle of lights visible to the technician. These triangles are representative of arrows that show the direction in which the vehicle should move. If directional LED 770 is on, the car should be repositioned forward. If directional LED 775 is on, the car should be reversed. If directional LED 785 is on, the car should be repositioned in the left direction by turning the steering wheel counterclockwise and accelerating or stopping, as appropriate. If directional LED 780 is on, the car should be repositioned to the right by turning the steering wheel clockwise and accelerating or stopping, as appropriate. If all LEDs are on, the car should no longer be moved because it has been properly positioned.

The present system has been described with reference to certain exemplary embodiments. However, it will be readily apparent to those skilled in the art that it is possible to embody the system in forms other than these embodiments. This may be done without departing from the spirit of the disclosure. The embodiments are merely illustrative and should not be considered restrictive in any way. The scope of the system are given by the appended claims, rather than the preceding description, and all variations and equivalents that fall within the range of the claims are intended to be embraced.

1. A three-dimensional camera based position determination system, comprising:
an optically scannable target device fixedly attached to a target object;
at least one camera and light subsystem, each subsystem having:
an image sensing device configured to view the optically scannable target device and to generate image information indicative of geometric characteristics of the target device; and
at least one invisible light emitting diode operatively coupled to a strobe circuit, the at least one diode and circuit being configured to emit strobed invisible light thereby illuminating the optically scannable target such that the light is retro-reflected to the image sensing device and the image sensing device detects and forms an image of the target;
a data processing device operatively coupled to the image sensing device, the data processing device being configured to determine the orientation of the target object based on the generated target image, and
a visible indicator that indicates whether the at least one invisible light emitting diode is operative.

2. The position determination system as recited in claim 1, wherein the invisible light is infrared light.

3. The position determination system as recited in claim 2, wherein the visible indicator emits light within the visible spectrum, and thereby indicates that the at least one invisible light emitting diode is operative.

4. The position determination system as recited in claim 1, wherein the at least one invisible light emitting diode is an array of light emitting diodes.

5. The position determination system as recited in claim 4, wherein the number of invisible light emitting diodes in the array is sixty-four.

6. The position determination system as recited in claim 4, wherein the number of invisible light emitting diodes in the array is eighty.

7. The position determination system as recited in claim 1 wherein the target object is a vehicle wheel, and the data processing device is further configured to determine proper wheel alignment based on orientation of the vehicle wheel.

8. The position determination system as recited in claim 3, wherein the image sensing device includes an electronic shutter that is synchronized with the at least one strobed light emitting diode such that an image is captured only when a target is illuminated.

9. The position determination system as recited in claim 8, wherein the image sensing device is a charge-coupled device video camera.

10. The position determination system as recited in claim 8, wherein the image sensing device is a complimentary metal oxide semiconductor camera.

11. (Cancelled)

12. The position determination system as recited in claim 1, further comprising:
a current source configured to supply a current to the at least one invisible light emitting diode.

13. A three-dimensional camera based position determination system, comprising:
an optically scannable target device fixedly attached to a target object;
at least one camera and light subsystem, each subsystem having:
an image sensing device configured to view the optically scannable target device and to generate image information indicative of geometric characteristics of the target device; and
at least one light emitting diode operatively coupled to a strobe circuit, the at least one diode and circuit being configured to emit strobed light thereby illuminating the optically scannable target such that the light is retro-reflected to the image sensing device and the image sensing device detects and forms an image of the target;
a data processing device operatively coupled to the image sensing device, the data processing device being configured to determine the orientation of the target object based on the generated target image; and
a target object indicator that displays the status of target acquisition by the data processing device, wherein the status of target acquisition indicates whether an obtained image of the scannable target device is acceptable.

14. The position determination system as recited in claim 13 wherein the target object indicator comprises:
a target object indicator array that includes at least one set of target object indicator light emitting diodes, wherein each light emitting diode of the first set corresponds to a target object;
wherein the target object indicator array further includes a second set of target object indicator light emitting diodes, wherein each light emitting diode of the second set corresponds to a target object; and
wherein the target object indicator array is operatively coupled to the data processing device such that the first set of target object light emitting diodes is energized when an image of the target object is acquired by the data processing device, thereby indicating that the target object is acquired by the data processing device, and the second set of target object light emitting diodes is energized when an image of the target object is not acquired by the data processing device, thereby indicating that the target object is not acquired by the data processing device.

15. The position determination system as recited in claim 13, further comprising:
at least two sets of directional light arrays, each of the sets of directional light arrays including at least one directional light emitting diode, and wherein, the at least two sets of directional light arrays are operatively coupled to the image sensing device such that when a single set of directional light is energized, a direction is indicated in which the target object should be repositioned such that the image sensing device may sense the target object and wherein, when all directional light arrays are on, the target object has been properly positioned.

16. The position determination system as recited in claim 15, wherein the number of directional light arrays is four, and the directions in which the vehicle should be repositioned as indicated by the four arrays are backward, forward, left and right.

17. A three-dimensional camera based position determination system, comprising:
sensing means for sensing an image of a target device, and generating image information indicative of geometric characteristics of the target device; and
emission means for emitting strobed invisible light that illuminates the optically scannable target such that the light is retro-reflected to the image sensing device and the image sensing device detects and forms an image of the target;
data processing means for determining the orientation of the target object based on the generated target image; and
visible indicator means for visibly indicating whether the emission means is operative.

18. The position determination system as recited in claim 17, wherein the invisible light is infrared light.

19. The position determination system as recited in claim 18, wherein the visible indicator means emits light within the visible spectrum, and thereby indicates that the emission means is operative.

20. The position determination system as recited in claim 17, wherein the target object is a vehicle wheel, and the data processing means is configured to determine proper wheel alignment based on orientation of the vehicle wheel.

21. The position determination system as recited in claim 17, wherein the image sensing means includes an electronic shutter that is synchronized with the emission means such that an image is captured only when a target is illuminated.

22. The position determination system as recited in claim 17, further comprising:
attachment means for fixedly attaching an optically scannable target device to a target object.

23. The position determination system as recited in claim 17, further comprising:
directional means for indicating the direction in which a target object should be repositioned, and for indicating that a target object has been properly positioned.

24. The position determination system as recited in claim 17, further comprising:
target object indicator means for indicating that the sensing means is sensing the target object.

25. The position determination system as recited in claim 17, further comprising:
target object indicator means for indicating the state of target acquisition by the data processing device.

26. An image-based position determination system for optically scanning a target device related to an object, the system comprising:
at least one camera and light subsystem, each subsystem having:
an image sensing device configured to view the target device and to generate image information indicative of geometric characteristics of the target device;
at least one light emitting diode operatively coupled to a strobe circuit, the at least one diode and circuit being configured to emit strobed light thereby illuminating the target device such that the light is retro-reflected to the image sensing device and the image sensing device detects and forms an image of the target; and
a visual indicator for indicating a direction by which the object should be moved relative to the image sensing device; and
a data processing device configured to couple to the visual indicator and the image sensing device to determine the orientation of the object based on the generated target image.

27. An image-based position determination system for optically scanning a target device related to an object, the system comprising:
image sensing means for viewing the target device and for generating image information indicative of geometric characteristics of the target device;
light emitting means for emitting strobed light thereby illuminating the target device such that the light is retro-reflected to the image sensing means and the image sensing means detects and forms an image of the target; and
visual indicator means for indicating a direction by which the object should be moved relative to the image sensing means; and
a data processing device configured to couple to the visual indicator means and the image sensing means to determine the orientation of the object based on the generated target image.

28. The system of claim 13 further comprising:
directional means for indicating the direction in which the target object should be repositioned, and for indicating whether the target object has been properly positioned.
